(19) United States
(12) Patent Application Publication
(10) Pub. No.: US 2024/0290979 A1
(43) Pub. Date: Aug. 29, 2024

(54) NEGATIVE ELECTRODE COMPOSITE MATERIAL SLURRY, NEGATIVE ELECTRODE, AND METHOD OF PRODUCING NEGATIVE ELECTRODE COMPOSITE MATERIAL SLURRY

(71) Applicant: Prime Planet Energy & Solutions, Inc., Tokyo (JP)

(72) Inventors: Hideki SANO, Osaka (JP); Kouhei TSUZUKI, Kobe-shi (JP); Natsumi OZASA, Amagasaki-shi (JP)

(21) Appl. No.: 18/413,031

(22) Filed: Jan. 16, 2024

(30) Foreign Application Priority Data
Feb. 27, 2023 (JP) 2023-028110

(51) Int. Cl. H01M 4/62; C01B 32/956; H01M 4/04; H01M 4/133; H01M 4/134; H01M 4/1393; H01M 4/1395; H01M 4/36; H01M 4/38; H01M 4/587; H01M 10/42

(52) U.S. Cl. CPC H01M 4/62; C01B 32/956; H01M 4/0404; H01M 4/133; H01M 4/134; H01M 4/1393; H01M 4/1395; H01M 4/364; H01M 4/386; H01M 4/587; H01M 10/4235; C01P 2006/40; H01M 2004/027

(57) ABSTRACT

A negative electrode composite material slurry comprises a negative electrode active material including a Si-based active material, one or more auxiliary materials selected from the group consisting of polyacrylic acid, styrene-butadiene rubber, carboxymethylcellulose, and carbon nanotubes, and water. The negative electrode composite material slurry has a pH from 4.5 to 7.3.

### CROSS REFERENCE TO RELATED APPLICATIONS

This nonprovisional application is based on Japanese Patent Application No. 2023-028110 filed on Feb. 27, 2023, with the Japan Patent Office, the entire contents of which are hereby incorporated by reference.

### BACKGROUND OF THE INVENTION

### Field of the Invention

The present invention relates to a negative electrode composite material slurry, a negative electrode, and a method of producing a negative electrode composite material slurry.

### Description of the Background Art

A lithium-ion secondary battery has a negative electrode, and the negative electrode has a negative electrode active material layer. The negative electrode active material layer is formed with the use of a negative electrode composite material slurry that includes a negative electrode active material. As the negative electrode active material, carbon-based active material as well as Si-based active material are known.

Japanese Patent No. 7084849 discloses an aqueous negative electrode slurry including a Li-doped silicon material, having enhanced stability, and having reduced gas production during high-temperature storage.

### SUMMARY OF THE INVENTION

In Japanese Patent No. 7084849, when Li (which is doped on the silicon material) comes into contact with water and thereby lithium ions are eluted, hydrogen gas may be produced. The inventors of the present invention have found that gas production also occurs from a negative electrode composite material slurry in which the negative electrode active material does not include Li. The gas produced from the negative electrode composite material slurry can cause dot-shaped defects on the coating made of the negative electrode composite material slurry, also potentially causing dot-shaped defects to the negative electrode active material layer. Because of this, there is a demand for further reduction of gas production from the negative electrode composite material slurry.

An object of the present disclosure is to provide a negative electrode composite material slurry that is capable of reducing gas production, a negative electrode obtained by using the same, and a method of producing the negative electrode composite material slurry.

[1] A negative electrode composite material slurry comprising:
a negative electrode active material including a Si-based active material;
one or more auxiliary materials selected from the group consisting of polyacrylic acid, styrene-butadiene rubber, carboxymethylcellulose, and carbon nanotubes; and
water, wherein
the negative electrode composite material slurry has a pH from 4.5 to 7.3.

[2] The negative electrode composite material slurry according to [1], wherein the negative electrode composite material slurry further includes a buffer agent.

[3] The negative electrode composite material slurry according to [2], wherein the buffer agent is one or more selected from the group consisting of phosphoric acid, acetic acid, citric acid, and a salt thereof.

[4] The negative electrode composite material slurry according to any one of [1] to [3], wherein the negative electrode composite material slurry has a pH from 4.5 to 7.0.

[5] The negative electrode composite material slurry according to any one of [1] to [4], wherein the Si-based active material includes SiC particles having an oxygen content from 1 mass % to 8 mass %.

[6] The negative electrode composite material slurry according to any one of [1] to [5], wherein
the negative electrode active material further includes a carbon-based active material, and
a content of the Si-based active material relative to a total amount of the negative electrode active material is from 2 mass % to 50 mass %.

[7] A negative electrode having a negative electrode active material layer, wherein
the negative electrode active material layer includes:
   a negative electrode active material including a Si-based active material;
   one or more auxiliary materials selected from the group consisting of polyacrylic acid, styrene-butadiene rubber, carboxymethylcellulose, and carbon nanotubes; and
   one or more buffer agents selected from the group consisting of phosphoric acid, acetic acid, citric acid, and a salt thereof.

[8] The negative electrode according to [7], wherein the Si-based active material includes SiC particles having an oxygen content from 1 mass % to 8 mass %.

[9] A negative electrode having a negative electrode active material layer obtained by using the negative electrode composite material slurry according to any one of [1] to [6].

[10] A method of producing a negative electrode composite material slurry, the method comprising mixing:
a negative electrode active material including a Si-based active material;
one or more auxiliary materials selected from the group consisting of polyacrylic acid, styrene-butadiene rubber, carboxymethylcellulose, and carbon nanotubes;
a buffer solution having a pH from 4.5 to 7.0; and
water.

[11] The method according to [10], wherein the negative electrode composite material slurry has a pH from 4.5 to 7.3.

[12] The method according to [10] or [11], wherein
the buffer solution is an aqueous solution of a buffer agent, and
the buffer agent is one or more selected from the group consisting of phosphoric acid, acetic acid, citric acid, and a salt thereof.

[13] The method according to any one of [10] to [12], comprising:
obtaining a mixed-kneaded body by mixing and high-shear kneading the negative electrode active material, the auxiliary material, and the buffer solution; and
diluting the mixed-kneaded body with water.

[14] The method according to [13], wherein
the auxiliary material mixed in the obtaining a mixed-kneaded body is polyacrylic acid, carboxymethylcellulose, and carbon nanotubes, and
the diluting includes mixing the mixed-kneaded body, water, and styrene-butadiene rubber.

[15] A method of producing a negative electrode, the method comprising:
obtaining a negative electrode composite material slurry;
applying the negative electrode composite material slurry to a negative electrode current collector; and
drying the negative electrode composite material slurry thus applied, wherein
the obtaining a negative electrode composite material slurry involves mixing:
   a negative electrode active material including a Si-based active material;
   one or more auxiliary materials selected from the group consisting of polyacrylic acid, styrene-butadiene rubber, carboxymethylcellulose, and carbon nanotubes;
   a buffer solution having a pH from 4.5 to 7.0; and
   water.

The foregoing and other objects, features, aspects and advantages of the present disclosure will become more apparent from the following detailed description of the present disclosure when taken in conjunction with the accompanying drawings.

### BRIEF DESCRIPTION OF THE DRAWINGS

FIG. 1 is a flowchart illustrating a method of producing a negative electrode composite material slurry according to an embodiment.

### DESCRIPTION OF THE PREFERRED EMBODIMENTS

### (Negative Electrode Composite Material Slurry)

A negative electrode composite material slurry according to the present embodiment (hereinafter also called “the present slurry”) is used for forming a negative electrode active material layer of a negative electrode of a non-aqueous electrolyte secondary battery such as a lithium-ion secondary battery. The present slurry includes a negative electrode active material, an auxiliary material, and water, and has a pH from 4.5 to 7.3. The negative electrode active material includes a Si-based active material. The auxiliary material is one or more selected from the group consisting of polyacrylic acid (hereinafter also called “PAA”), styrene-butadiene rubber (hereinafter also called “SBR”), carboxymethylcellulose (hereinafter also called “CMC”), and carbon nanotubes (hereinafter also called “CNTs”). The present slurry may further include a buffer agent.

The pH of the present slurry is from 4.5 to 7.3, preferably from 4.5 to 7.0, may be from 4.5 to 6.9, more preferably from 4.7 to 6.7, further preferably from 4.7 to 6.5. The pH of the present slurry is a value at a temperature of 25° C., and may be measured with a pH meter.

The inventors of the present invention have found that a slurry including one or more auxiliary materials selected from the above-described group and water is weakly alkaline, and that when the weak alkaline slurry includes a Si-based active material, gas production tends to occur. The gas produced from the slurry is conjectured to be hydrogen gas produced by a reaction of silicon contained in the Si-based active material with an alkaline component, and/or by a charge compensation reaction that occurs upon elution of silicate ions from the Si-based active material. The present slurry has a pH within the above-described range, so the amount of gas produced from the present slurry can be reduced. As a result, the occurrence of dot-shaped defects can be reduced in a negative electrode active material layer formed with the use of the present slurry.

The pH of the present slurry may be adjusted by adjusting the component contained in the present slurry and the content thereof, or by adding a buffer solution described below while preparing the present slurry as described below, or by adjusting the pH of the buffer solution and the amount thereof, for example. The buffer solution is an aqueous solution that contains a buffer agent dissolved in water.

Preferably, the present slurry includes a buffer agent. When added in the form of buffer solution to a slurry and/or to a liquid such as a solution, the buffer agent can exhibit buffering action. The buffer agent can be a component, other than water (solvent), contained in the buffer solution which is added at the time of preparation of the present slurry. Examples of the buffer agent include a mixture that contains a weakly acidic compound and a conjugate base compound thereof, a compound that dissociates into a weak acid and a conjugate base thereof, a mixture that contains a weakly basic compound and a conjugate acid compound thereof, a compound that dissociates into a weak base and a conjugate acid thereof, and the like.

The buffer agent is not particularly limited in terms of the type and the content thereof as long as it can adjust the pH of the present slurry to fall within the above-described range. The buffer agent is one or more selected from the group consisting of phosphoric acid, acetic acid, citric acid, phthalic acid, and a salt thereof (a phosphoric acid salt, an acetic acid salt, a citric acid salt, and a phthalic acid salt), for example, and preferably one or more selected from the group consisting of phosphoric acid, acetic acid, citric acid, and a salt thereof. Examples of the salt thereof include a salt with an alkali metal such as potassium and sodium, a salt with an alkaline-earth metal such as magnesium and calcium, an ammonium salt, and the like. The buffer agent is more preferably one or more selected from the group consisting of a phosphoric acid salt, acetic acid and a salt thereof, and citric acid and a salt thereof, further preferably a mixture of sodium hydrogen phosphate and sodium dihydrogen phosphate, a mixture of acetic acid and sodium acetate, and a mixture of citric acid and sodium citrate.

The content of the buffer agent in the present slurry is simply required to be adjusted so that it can achieve the pH of the present slurry falling within the above-described range, and may be adjusted depending on the type, content, and the like of the auxiliary material in the present slurry.

The present slurry includes the negative electrode active material including a Si-based active material. In addition to a Si-based active material, the negative electrode active material may also include a carbon-based active material. Preferably, the Si-based active material does not include the elemental Li.

Examples of the Si-based active material include particles such as those of the elemental silicon, those of SiC (a composite material of silicon and carbon; for example, silicon nanoparticles dispersed inside porous carbon particles), and those of SiOx. The Si-based active material preferably includes SiC particles, more preferably it is SiC particles. Preferably, the SiC particles are particles that have silicon or silicon oxide film exposed on the surface. Although such SiC particles tend to react with an alkaline component to produce gas, the present slurry has a pH within the above-described range and thereby can reduce the amount of gas production even with SiC particles included therein. The SiC particles may include SiC particles having an oxygen content from 1 mass % to 10 mass %. The oxygen content of the SiC particles is preferably from 1 mass % to 8 mass %, and it may be from 1 mass % to 7 mass %, or may be from 2 mass % to 5 mass %. The oxygen content can be determined based on the amount of oxygen extracted by a heating/melting method in an inert gas with the use of an oxygen analyzer.

Examples of the carbon-based active material include carbon (C) such as graphite, hard carbon, soft carbon, and amorphous-coated graphite, and the like. Preferably, the carbon-based active material is graphite particles.

The content of the Si-based active material in the present slurry relative to the total amount of the negative electrode active material is preferably from 2 mass % to 50 mass %, and it may be from 3 mass % to 20 mass % or may be from 5 mass % to 15 mass %. The content of the carbon-based active material in the present slurry relative to the total amount of the negative electrode active material is preferably from 0 mass % to 98 mass %, and it may be from 80 mass % to 97 mass % or may be from 85 mass % to 95 mass %.

The present slurry includes one or more auxiliary materials selected from the group consisting of PAA, SBR, CMC, and CNTs, may include two or three auxiliary materials selected from the above group, and preferably includes PAA, SBR, CMC, and CNTs. Preferably, each of the PAA and the CMC is in the form of salt. Examples of the salt include a salt with an alkali metal such as lithium and sodium, and the like. The CNTs may be single-walled carbon nanotubes (SWCNTs) or may be multi-walled carbon nanotubes such as double-walled carbon nanotubes (DWCNTs), preferably SWCNTs. SWCNT is a carbon nanostructure which is a single cylindrical body composed of a single carbon hexagonal network layer.

The PAA used in the present slurry may have a pH from 7.0 to 10.0 or from 8.0 to 9.0 at a temperature of 25° C. in the form of a 2-mass % PAA aqueous solution.

The SBR used in the present slurry may have a pH from 6.0 to 9.0 or from 7.0 to 8.0 at a temperature of 25° C. in the form of an SBR aqueous dispersion.

The CMC used in the present slurry may have a pH from 6.2 to 8.0, or from 6.5 to 7.5, or from 6.8 to 7.3 at a temperature of 25° C. in the form of a 1-mass % CMC aqueous solution.

The CNTs used in the present slurry may have a pH from 7.0 to 10.0 or from 8.0 to 9.0 at a temperature of 25° C. in the form of a CNT aqueous dispersion. Each of these pHs may be measured with a pH meter.

The content of the auxiliary material in the present slurry relative to the total amount of the negative electrode active material is from 1.0 mass % to 15 mass %, for example, and it may be from 1.5 mass % to 10 mass % or from 2.0 mass % to 8 mass %. In the case where the present slurry includes two or more auxiliary materials, the content of the auxiliary material refers to the total amount of the auxiliary materials included in the present slurry. The content of PAA, SBR, or CMC in the present slurry relative to the total amount of the negative electrode active material may be independently from 0.1 mass % to 5.0 mass %, or from 0.3 mass % to 3.0 mass %, or from 0.5 mass % to 2.0 mass %. The content of the CNTs in the present slurry relative to the total amount of the negative electrode active material may be from 0.01 mass % to 3.0 mass %, or from 0.02 mass % to 2.0 mass %, or from 0.03 mass % to 1.0 mass %.

The present slurry may further include polyethylene oxide (PEO), polyacrylonitrile (PAN), acrylonitrile butadiene rubber (NBR), polytetrafluoroethylene (PTFE), methylcellulose (MC), carbon black, coke, activated carbon, fullerene, graphene, and/or the like, for example.

### (Method of Producing Negative Electrode Composite Material Slurry)

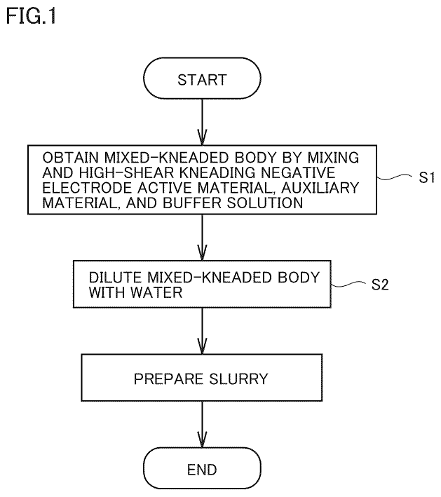

FIG. 1 is a flowchart illustrating a method of producing a negative electrode composite material slurry according to an embodiment. The method of producing a negative electrode composite material slurry (hereinafter also called “the present method”) involves mixing:
a negative electrode active material including a Si-based active material;
one or more auxiliary materials selected from the group consisting of polyacrylic acid, styrene-butadiene rubber, carboxymethylcellulose, and carbon nanotubes;
a buffer solution having a pH from 4.5 to 7.0; and
water.

By the present method, it is possible to reduce the amount of gas produced from the negative electrode composite material slurry. The present method may be a method of producing the present slurry. In this case, the pH of the negative electrode composite material slurry produced by the present method may be within the pH range described above for the present slurry. With this, the amount of gas produced from the negative electrode composite material slurry can be further reduced.

Examples of the Si-based active material, the negative electrode active material, and the auxiliary material used in the present method include those described above. The content of the Si-based active material and the auxiliary material included in the negative electrode composite material slurry may be within the range of content described above for the present slurry, for example.

The buffer solution is an aqueous solution of a buffer agent dissolved in water. Examples of the buffer agent include those described above. The buffer agent is preferably one or more selected from the group consisting of phosphoric acid, acetic acid, citric acid, and a salt thereof, more preferably one or more selected from the group consisting of a phosphoric acid salt, acetic acid and a salt thereof, and citric acid and a salt thereof, further preferably a mixture of sodium hydrogen phosphate and sodium dihydrogen phosphate, a mixture of acetic acid and sodium acetate, and a mixture of citric acid and sodium citrate.

The pH of the buffer solution is from 4.5 to 7.0, preferably from 4.7 to 6.9, and it may be from 4.7 to 6.5. The pH of the buffer solution is a value at a temperature of 25° C., and may be measured with a pH meter.

As shown in FIG. 1, the present method preferably includes obtaining a mixed-kneaded body by mixing and high-shear kneading the negative electrode active material, the auxiliary material, and the buffer solution (hereinafter also called “a step (S1)”) and diluting the mixed-kneaded body with water (hereinafter also called “a step (S2)”).

In the step (Si) of the present method, the negative electrode active material, the auxiliary material, and the buffer solution are mixed, to which water is added as needed, and the resultant is high-shear kneaded to obtain a mixed-kneaded body. The auxiliary material mixed in the step (S1) is preferably one or more selected from the group consisting of PAA, CMC, and CNTs, and it may be two or three selected from the group, more preferably PAA, CMC, and CNTs.

It is conceivable that the mixed-kneaded body thus obtained in the step (S1) by high-shear kneading is in a state preceding a slurry state, namely, for example, in a funicular state. The slurry state refers to a state where the powder phase forms a discontiguous phase (namely, it is dispersed) in the liquid phase which is a contiguous phase. The funicular state refers to the following state: the liquid phase is a contiguous phase; a gas phase (air) is present; and the powder phase is a contiguous phase where powder is in contact with each other. The high-shear kneading carried out in the step (Si) refers to mixing and kneading together the negative electrode active material, the auxiliary material, and the buffer solution, and also water as needed, so that a mixed-kneaded body is to be obtained in a state preceding a slurry state (in a funicular state, for example).

The step (S1) may include:
a step (S1-1) that involves mixing the negative electrode active material with a material which is part of the auxiliary material and provided in a powder state, to obtain a mixed powder; and
a step (S1-2) that involves adding, to the mixed powder, an auxiliary material (which is part of the auxiliary material, includes a liquid such as water, and is provided in a liquid state), and the buffer solution, and also water as needed, and performing high-shear kneading. Examples of the auxiliary material that is provided in a powder state include PAA, CMC, and the like. Examples of the auxiliary material that is provided in a liquid state include a PAA aqueous solution, a CNT aqueous dispersion, an SBR aqueous dispersion, and the like. The steps (S1), (S1-1), and (S1-2) can be performed with the use of a mixer such as a planetary mixer.

The step (S2) is a step that involves diluting the mixed-kneaded body obtained in the step (S1), with water. In the step (S2), mixing and kneading is carried out while water is being added to the mixed-kneaded body so as to achieve the viscosity of the negative electrode composite material slurry intended to be produced in the present method. If needed, mixing and kneading may be carried out with a part of the auxiliary material being further added thereto.

The step (S2) may include mixing the mixed-kneaded body obtained in the step (S1), and water, and also the auxiliary material as needed. The step (S2) may include a step (S2-1) that involves adding water to the mixed-kneaded body for dilution, and a step (S2-2) that involves performing mixing and kneading while the auxiliary material is being added to the mixed-kneaded body thus diluted in the step (S2-1). The amount of water added in the step (S2-1) is adjusted so as to achieve the viscosity of the negative electrode composite material slurry intended to be obtained in the present method, for example.

Preferably, the auxiliary material added in the step (S2-2) is an auxiliary material that is not added in the step (S1). For example, the step (Si) may involve adding one or two selected from the group consisting of PAA, CMC, and CNTs, or PAA, CMC, and CNTs, in the step (S1), and adding SBR in the step (S2-2). Preferably, PAA, CMC, and CNTs are added in the step (Si) and SBR is added in the step (S2-2). The steps (S2), (S2-1), and (S2-2) can be performed with the use of a mixer such as a planetary mixer.

Although the buffer solution is preferably added in the step (S1), it may be added in the step (S2). In the case where the buffer solution is added in the step (S2), the negative electrode active material and the auxiliary material, and also water as needed, may be mixed and high-shear kneaded to obtain a mixed-kneaded body, and then the buffer solution and water, and also the auxiliary material as needed, may be added to the resulting mixed-kneaded body to dilute the mixed-kneaded body.

Examples of the auxiliary material added at the time of high-shear kneading include the auxiliary material added in the step (S1), and examples of the auxiliary material added at the time of dilution of the mixed-kneaded body include the auxiliary material added in the step (S2-2).

### (Negative Electrode)

The negative electrode according to the present embodiment has a negative electrode active material layer. The negative electrode may have the negative electrode active material layer on a negative electrode current collector. For example, the negative electrode current collector is a metal foil configured with the use of a copper material such as copper and copper alloy. The negative electrode may be used for a non-aqueous electrolyte secondary battery such as a lithium-ion secondary battery.

The negative electrode active material layer of the negative electrode may include:
a negative electrode active material including a Si-based active material;
one or more auxiliary materials selected from the group consisting of polyacrylic acid, styrene-butadiene rubber, carboxymethylcellulose, and carbon nanotubes; and
one or more buffer agents selected from the group consisting of phosphoric acid, acetic acid, citric acid, and a salt thereof. The negative electrode active material layer including the buffer agent is formed with the use of a negative electrode composite material slurry with reduced gas production, and is thereby conceivable to have reduced occurrence of dot-shaped defects.

Examples of the Si-based active material, the negative electrode active material, the auxiliary material, and the buffer agent include those described above. The auxiliary material may include two or three selected from the above-described group, and preferably includes PAA, SBR, CMC, and CNTs. Each of the content proportion of the Si-based active material in the negative electrode active material, and the content of the auxiliary material relative to the total amount of the negative electrode active material, may be within the range described above for the present slurry, for example.

The negative electrode active material layer of the negative electrode may be the negative electrode active material layer obtained from the present slurry. For example, the negative electrode may be obtained by applying the present slurry to the negative electrode current collector and performing drying, compressing, and the like.

The method of producing a negative electrode may include a step of obtaining the negative electrode composite material slurry, a step of applying the negative electrode composite material slurry to the negative electrode current collector, and a step of drying the negative electrode composite material slurry thus applied. The step of obtaining the negative electrode composite material slurry may be a step that involves mixing a negative electrode active material including a Si-based active material, one or more auxiliary materials selected from the group consisting of polyacrylic acid, styrene-butadiene rubber, carboxymethylcellulose, and carbon nanotubes, a buffer solution having a pH from 4.5 to 7.0, and water. The pH of the buffer solution is a value at a temperature of 25° C., and may be measured with a pH meter.

Examples of the Si-based active material, the negative electrode active material, the auxiliary material, and the buffer solution used in the method of producing a negative electrode include those described above. The content of the Si-based active material and the auxiliary material included in the negative electrode composite material slurry, as well as the pH of the buffer solution, may be within the content range and the pH range described above for the present slurry, for example. The step of obtaining the negative electrode composite material slurry may be the method and the step describe above for the present method.

The present slurry achieves reduced gas production. As a result, the occurrence of dot-shaped defects on a coating that is formed by application of the present slurry to the negative electrode current collector can be reduced, and thereby it is conceivable that a negative electrode having a negative electrode active material layer with reduced dot-shaped defects can be obtained.

### (Non-Aqueous Electrolyte Secondary Battery)

A non-aqueous electrolyte secondary battery (hereinafter also called “a secondary battery”) includes an electrode assembly and an electrolyte. The secondary battery may include an exterior package for accommodating the electrode assembly and the electrolyte, and, between the electrode assembly and the exterior package, a resin sheet may be provided as an electrode holder.

The electrode assembly includes the above-described negative electrode, a positive electrode, and a separator. At the electrode assembly, the negative electrode active material layer of the negative electrode faces a positive electrode active material layer of the positive electrode, with the separator interposed therebetween. The electrode assembly may be a wound-type one, or may be a stack-type one.

The positive electrode usually has a positive electrode current collector and a positive electrode active material layer, and, for example, the positive electrode current collector is a metal foil that is configured with the use of an aluminum material such as aluminum and aluminum alloy. As the positive electrode active material layer, a material that is known in the field of secondary batteries may be used.

As each of the separator and the electrolyte, a material that is known in the field of secondary batteries may be used.

### EXAMPLES

In the following, the present disclosure will be described in further detail by way of Examples and Comparative Example.

### [Preparation of Negative Electrode Active Material]

As a negative electrode active material, graphite particles as well as SiC particles as a Si-based active material were prepared. The SiC particles were silicon nanoparticles dispersed inside porous carbon particles, and Si or Si oxide film was exposed on at least part of the surface. The oxygen content of the SiC was calculated from the amount of oxygen extracted by a heating/melting method in an inert gas with the use of an oxygen analyzer, and it was within the range of 1 mass % to 10 mass %.

### [Preparation of Buffer Solution]

As a buffer solution, buffer solutions (1) to (3) described below were prepared. The pH of each buffer solution was the pH at a temperature of 25° C. and measured with a pH meter.

### (Preparation of Buffer Solution (1))

A 0.025-mol/L aqueous solution of sodium dihydrogen phosphate (NaH₂PO₄) and a 0.025-mol/L aqueous solution of sodium hydrogen phosphate (Na₂HPO₄) were mixed to obtain a buffer solution (1) of pH6.9.

### (Preparation of Buffer Solution (2))

A 0.013-mol/L aqueous solution of sodium dihydrogen phosphate (NaH₂PO₄) and a 0.037-mol/L aqueous solution of sodium hydrogen phosphate (Na₂HPO₄) were mixed to obtain a buffer solution (2) of pH6.4.

### (Preparation of Buffer Solution (3))

A 0.1-mol/L aqueous solution of acetic acid (CH₃COOH) and a 0.1-mol/L aqueous solution of sodium acetate (CH₃COONa) were mixed to obtain a buffer solution (3) of pH4.7.

### Comparative Example 1

Certain weights of the negative electrode active material prepared in the above-described manner, powder CMC, and powder PAA were mixed in a planetary mixer to obtain a mixed powder. To the resulting mixed powder, certain weights of an SWCNT aqueous dispersion and water were added, and high-shear kneading was carried out in the planetary mixer to obtain a mixed-kneaded body (a high-shear kneading step). Water was added to the resulting mixed-kneaded body for dilution so as to achieve the viscosity of the final product negative electrode composite material slurry, and addition of a certain weight of an SBR aqueous dispersion as well as mixing and kneading in the planetary mixer were carried out (a dilution step) to obtain a negative electrode composite material slurry. The resulting negative electrode composite material slurry had a composition of (graphite particles)/(SiC particles)/PAA/CMC/SBR/SWCNTs/water-90/10/1/1/1/0.05/106 (mass ratio).

As for the aqueous solution prepared by dissolving the CMC and the PAA in water, as well as for the SWCNT aqueous dispersion and the SBR aqueous dispersion, the pH at a temperature of 25° C. was measured with a pH meter. The pH of the 1-mass % aqueous CMC solution was 7.0, and the pH of the 2-mass % PAA aqueous solution was 8.4. The pH of the SWCNT aqueous dispersion was 9.0, and the pH of the SBR aqueous dispersion was 7.8.

### Examples 1 to 4

Negative electrode composite material slurries were obtained in the same manner as in Comparative Example 1 except that in the high-shear kneading step of Comparative Example 1, in addition to the SWCNT aqueous dispersion and water, the buffer solution as specified in Table 1 was added to the mixed powder in the parts by mass as specified in Table 1 and high-shear kneading was performed to obtain a mixed-kneaded body.

### Example 5

A negative electrode composite material slurry was obtained in the same manner as in Comparative Example 1 except that in the dilution step of Comparative Example 1, 3 parts by mass of the buffer solution specified in Table 1 as well as water were added to the mixed-kneaded body for dilution, an SBR aqueous dispersion was added, and mixing and kneading was carried out in a planetary mixer.

### [Measurement of pH of Negative Electrode Composite Material Slurry]

At a temperature of 25° C., with a pH meter, the pH of the negative electrode composite material slurry was measured. Results are shown in Table 1.

### [Measurement of Amount of Gas Production]

Into a laminate pouch, 1 g of the negative electrode composite material slurry was placed. After a vacuum was created inside the laminate pouch, the laminate pouch was sealed to be used as a measurement sample. By a buoyancy method, the volume V1 of the measurement sample was measured indoors at a temperature of 22±1° C. The measurement sample was left inside a thermostatic chamber for two days at a temperature of 45° C. After taken out of the thermostatic chamber, the measurement sample was left indoors for one hour at a temperature of 22±1° C., and then the volume V2 of the measurement sample was measured by a buoyancy method.

The volume V1 was subtracted from the volume V2, and the resulting value was regarded as the amount of gas [cc/g] produced from the negative electrode composite material slurry. Results are shown in Table 1.

TABLE 1

| | Comp. | | | | | |
|---|---|---|---|---|---|---|
| | Ex. | Ex. | | | | |
| | 1 | 1 | 2 | 3 | 4 | 5 |
| Buffer solution | | | | | | |
| Type | — | (1) | (1) | (2) | (3) | (1) |
| pH | — | 6.9 | 6.9 | 6.4 | 4.7 | 6.9 |
| Amount added [parts by mass] | — | 1 | 3 | 3 | 5 | 3 |
| Step to add buffer solution | — | High- | High- | High- | High- | Dilution |
| | | shear | shear | shear | shear | step |
| | | kneading | kneading | kneading | kneading | |
| | | step | step | step | step | |
| Negative electrode composite | | | | | | |
| material slurry | | | | | | |
| pH | 7.5 | 7.3 | 6.9 | 6.5 | 4.7 | 6.9 |
| Amount of gas production [cc/g] | 0.15 | 0.12 | 0.06 | 0.03 | 0.02 | 0.07 |

Although the embodiments of the present disclosure have been described, the embodiments disclosed herein are illustrative and non-restrictive in any respect. The scope of the present disclosure is defined by the terms of the claims, and is intended to encompass any modifications within the meaning and the scope equivalent to the terms of the claims.

What is claimed is:

1. A negative electrode composite material slurry comprising:
a negative electrode active material including a Si-based active material;
one or more auxiliary materials selected from the group consisting of polyacrylic acid, styrene-butadiene rubber, carboxymethylcellulose, and carbon nanotubes; and
water, wherein
the negative electrode composite material slurry has a pH from 4.5 to 7.3.

2. The negative electrode composite material slurry according to claim 1, wherein the negative electrode composite material slurry further includes a buffer agent.

3. The negative electrode composite material slurry according to claim 2, wherein the buffer agent is one or more selected from the group consisting of phosphoric acid, acetic acid, citric acid, and a salt thereof.

4. The negative electrode composite material slurry according to claim 1, wherein the negative electrode composite material slurry has a pH from 4.5 to 7.0.

5. The negative electrode composite material slurry according to claim 1, wherein the Si-based active material includes SiC particles having an oxygen content from 1 mass % to 8 mass %.

6. The negative electrode composite material slurry according to claim 1, wherein
the negative electrode active material further includes a carbon-based active material, and
a content of the Si-based active material relative to a total amount of the negative electrode active material is from 2 mass % to 50 mass %.

7. A negative electrode having a negative electrode active material layer, wherein
the negative electrode active material layer includes:
a negative electrode active material including a Si-based active material;
one or more auxiliary materials selected from the group consisting of polyacrylic acid, styrene-butadiene rubber, carboxymethylcellulose, and carbon nanotubes; and
one or more buffer agents selected from the group consisting of phosphoric acid, acetic acid, citric acid, and a salt thereof.

8. The negative electrode according to claim 7, wherein the Si-based active material includes SiC particles having an oxygen content from 1 mass % to 8 mass %.

9. A negative electrode having a negative electrode active material layer obtained by using the negative electrode composite material slurry according to claim 1.

10. A method of producing a negative electrode composite material slurry, the method comprising mixing:
a negative electrode active material including a Si-based active material;
one or more auxiliary materials selected from the group consisting of polyacrylic acid, styrene-butadiene rubber, carboxymethylcellulose, and carbon nanotubes;
a buffer solution having a pH from 4.5 to 7.0; and
water.

11. The method according to claim 10, wherein the negative electrode composite material slurry has a pH from 4.5 to 7.3.

12. The method according to claim 10, wherein
the buffer solution is an aqueous solution of a buffer agent, and
the buffer agent is one or more selected from the group consisting of phosphoric acid, acetic acid, citric acid, and a salt thereof.

13. The method according to claim 10, comprising:
obtaining a mixed-kneaded body by mixing and high-shear kneading the negative electrode active material, the auxiliary material, and the buffer solution; and
diluting the mixed-kneaded body with water.

14. The method according to claim 13, wherein
the auxiliary material mixed in the obtaining a mixed-kneaded body is polyacrylic acid, carboxymethylcellulose, and carbon nanotubes, and
the diluting includes mixing the mixed-kneaded body, water, and styrene-butadiene rubber.

15. A method of producing a negative electrode, the method comprising:
obtaining a negative electrode composite material slurry;
applying the negative electrode composite material slurry to a negative electrode current collector; and
drying the negative electrode composite material slurry thus applied, wherein
the obtaining a negative electrode composite material slurry involves mixing:
a negative electrode active material including a Si-based active material;
one or more auxiliary materials selected from the group consisting of polyacrylic acid, styrene-butadiene rubber, carboxymethylcellulose, and carbon nanotubes;
a buffer solution having a pH from 4.5 to 7.0; and
water.
